(19) United States
(12) Patent Application Publication
(10) Pub. No.: US 2024/0351240 A1
(43) Pub. Date: Oct. 24, 2024

(54) FIBER COMPOSITE SYSTEMS AND APPLICATIONS

(71) Applicant: Fiber Global Inc., Orange, CA (US)

(72) Inventors: KC Wayne McCreery, Orange, CA (US); Dingming Zou, Maitland, FL (US); Christine Nicole Kappeyne van de Coppello, New York, NY (US)

(73) Assignee: Fiber Global Inc., Orange, CA (US)

(21) Appl. No.: 18/642,803

(22) Filed: Apr. 22, 2024

Related U.S. Application Data
(60) Provisional application No. 63/497,718, filed on Apr. 22, 2023.
(60) Provisional application No. 63/497,719, filed on Apr. 22, 2023.

(51) Int. Cl. B27N 3/04; B27N 1/02; B27N 3/00

(52) U.S. Cl. CPC B27N 3/04; B27N 1/0227; B27N 3/002

(57) ABSTRACT

A system and method for manufacturing a cardboard fiber composite, including: a multi-stage fiber refining system configured to generate milled cardboard fibers by reducing cardboard into a predetermined particle size threshold suitable for further processing; a bio-based epoxy resin dispensing system including a motorized airless sprayer configured to generate resin-applied cardboard fibers by atomizing and applying a bio-based epoxy resin into a mixing system; the mixing system including a mixer equipped with a plurality of blades, configured to blend the resin-applied cardboard fibers with the bio-based epoxy resin to a predefined distribution threshold; and a heat press forming system including at least one mechanical shim, configured to form the blended resin-applied cardboard fibers into a molded fiber composite material of a predefined shape and density.

### CROSS-REFERENCE TO RELATED APPLICATIONS

This application claims the benefit of U.S. Provisional Patent Application Ser. No. 63/497,718, Attorney Docket fiber.00001.us.p.1, entitled “FORGED CARDBOARD FIBER STRUCTURAL COMPOSITES”, filed Apr. 22 2023, the entire disclosure of which is incorporated by reference herein, in its entirety, for all purposes.

This application claims the benefit of U.S. Provisional Patent Application Ser. No. 63/497,719, Attorney Docket fiber.00001.us.p.2, entitled “FORGED CARDBOARD FIBER STRUCTURAL COMPOSITES”, filed Apr. 22, 2023, including inventor KC Wayne McCreery, the entire disclosure of which is incorporated by reference herein, in its entirety, for all purposes.

This application is related to International Application No. PCT/______, also known as U.S. Patent Application Ser. No.______, Attorney Docket fiber.00001.us.n.1, entitled “FIBER COMPOSITE SYSTEMS AND APPLICATIONS”, filed Apr. 22, 2024, including inventor KC Wayne McCreery, the entire disclosure of which is incorporated by reference herein, in its entirety, for all purposes.

### BACKGROUND

Engineered wood and synthetic materials have long been pivotal in addressing the challenges associated with traditional lumber and natural wood materials. These composite materials offer a versatile and cost-effective solution to meet the diverse needs of various industries and applications. Among these engineered wood products, Medium Density Fiberboard (MDF) and High Density Fiberboard (HDF) stand out for their wide-ranging utility and economic viability.

Originating in the mid-20th century, MDF and HDF emerged as innovative alternatives to natural wood materials, providing solutions to several inherent limitations. Among these is the need for more consistent properties, uniform density, and enhanced dimensional stability compared to traditional lumber. The applications of MDF and HDF span across numerous industries, owing to their versatility and adaptability to various manufacturing processes. In the construction sector, these composite materials find extensive use in interior applications such as cabinetry, shelving, wall panels, and decorative moldings. Their smooth surface finish and uniform composition make them suitable for laminates, veneers, and painted finishes.

Beyond construction and furniture, MDF and HDF are abundant in packaging, signage, and other industrial applications where a durable and dimensionally stable material is required. Their affordability, ease of fabrication, and consistent quality make them preferred choices for a wide range of products, from retail displays to acoustic panels.

However, despite their widespread use and economic benefits, MDF and HDF pose significant environmental challenges. The production process, particularly the use of formaldehyde-based adhesives, raises concerns about indoor air quality and human health. Moreover, the reliance on virgin wood fibers as raw materials contributes to deforestation and habitat loss, exacerbating environmental degradation. Thus, there is a growing need for alternatives to traditional MDF/HDF and similar materials for both structural and non-structural applications.

### SUMMARY

In general, in one aspect, embodiments relate to systems and processes for manufacturing, packaging, and applications of fiber composite materials. This can include “upcycling” of cardboard or cardboard-based materials from a variety of sources. Fiber composite materials can be utilized for a variety of structural and/or non-structural applications.

In general, in one aspect, embodiments relate to a system for manufacturing a cardboard fiber composite. The system can include: a multi-stage fiber refining system configured to generate milled cardboard fibers by reducing cardboard into a predetermined particle size threshold suitable for further processing; a bio-based epoxy resin dispensing system including a motorized airless sprayer configured to generate resin-applied cardboard fibers by atomizing and applying a bio-based epoxy resin into a mixing system; the mixing system including a mixer equipped with a plurality of blades, configured to blend the resin-applied cardboard fibers with the bio-based epoxy resin to a predefined distribution threshold; and a heat press forming system including at least one mechanical shim, configured to form the blended resin-applied cardboard fibers into a molded fiber composite material of a predefined shape and density.

In general, in one aspect, embodiments relate to a system for manufacturing fiber composites. The system can include: a multi-stage fiber refining system configured to generate milled fiber pulp by reducing fiber material into a predetermined particle size threshold suitable for further processing; a resin treatment system configured to apply a resin into a blending apparatus; the blending apparatus for blending the fiber pulp with the resin to generate resin-applied fiber material, wherein the blending apparatus is configured to distribute the resin to within a predefined threshold of uniformity; and a press forming system capable of shaping the resin-applied fiber material into fiber composites of multiple shapes and densities using at least one selected from a group consisting of heat pressing, cold pressing, and ambient temperature pressing.

In general, in one aspect, embodiments relate to a method for manufacturing a cardboard fiber composite. The method can include: (i) reducing cardboard into milled cardboard fibers having a predetermined particle size suitable for further processing, (ii) atomizing and applying a bio-based epoxy resin into a mixing system, (iii) using the mixing system to blend the milled cardboard fibers with the bio-based epoxy resin to generate resin-applied cardboard fibers, and (iv) forming the resin-applied cardboard fibers into a molded fiber composite material of a predefined shape and density.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1A-1D, 2, and 3 show schematic diagrams of manufacturing systems, in accordance with one or more embodiments.

FIG. 4 shows an image of refined fiber pulp, in accordance with one or more embodiments.

FIG. 5 shows a table illustrating various metrics associated with materials produced using a forge press process, in accordance with one or more embodiments.

FIG. 6 shows a table illustrating various metrics associated with materials produced using a heat press process, in accordance with one or more embodiments.

FIG. 7 shows a graph depicting thickness versus compression time for manufacture of various cardboard fiber composites, in accordance with one or more embodiments.

FIG. 8 shows a graph depicting the heating and cooling cycle in the manufacture of a cardboard fiber composite, in accordance with one or more embodiments.

FIG. 9 shows a table illustrating dimensions of various cardboard fiber composite materials, in accordance with one or more embodiments.

FIG. 10 shows a flowchart depicting a manufacturing process for cardboard fiber composite, in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

In general, embodiments of the present disclosure provide systems and processes for manufacturing fiber composite materials for structural and non-structural applications. A manufacturing system is configured to transform or “upcycle” cardboard fiber into a fiber composite through a series of mechanical and chemical processes, including milling, resin application, blending, and molding. The system may be configured to utilize epoxy resins and advanced material handling techniques to produce composites suitable for various applications.

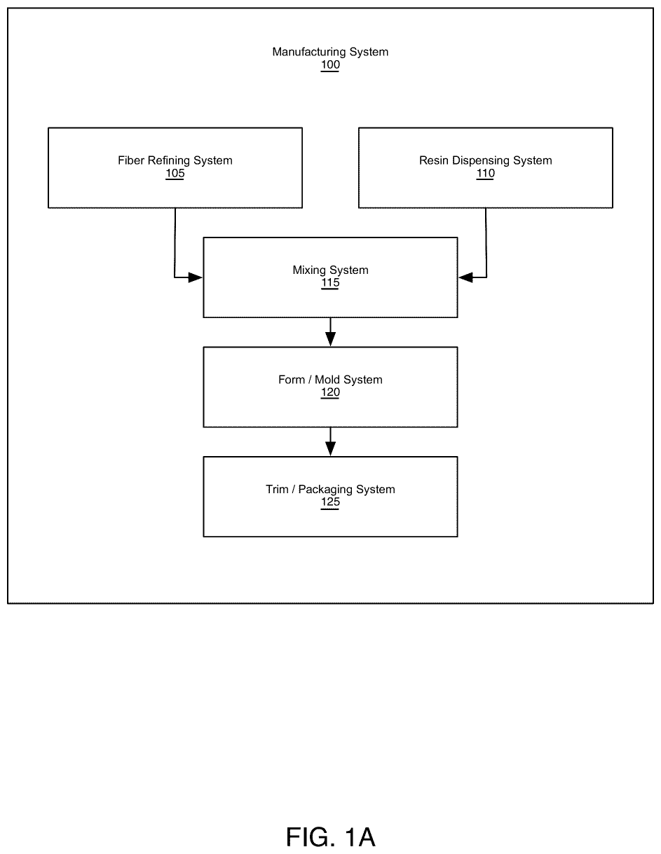

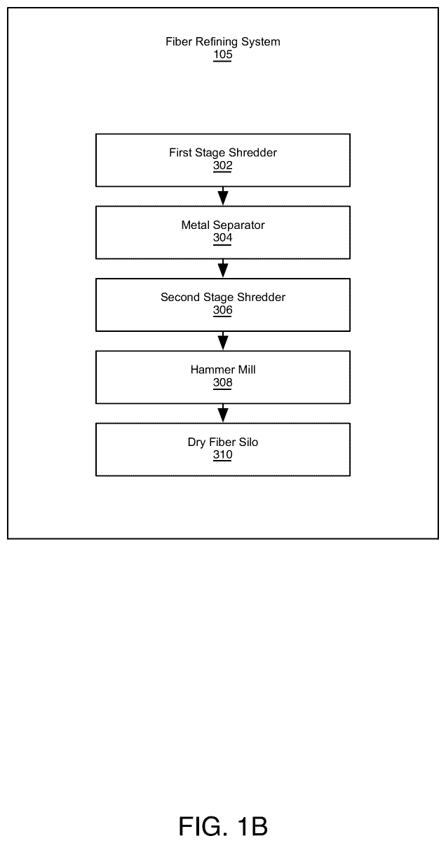

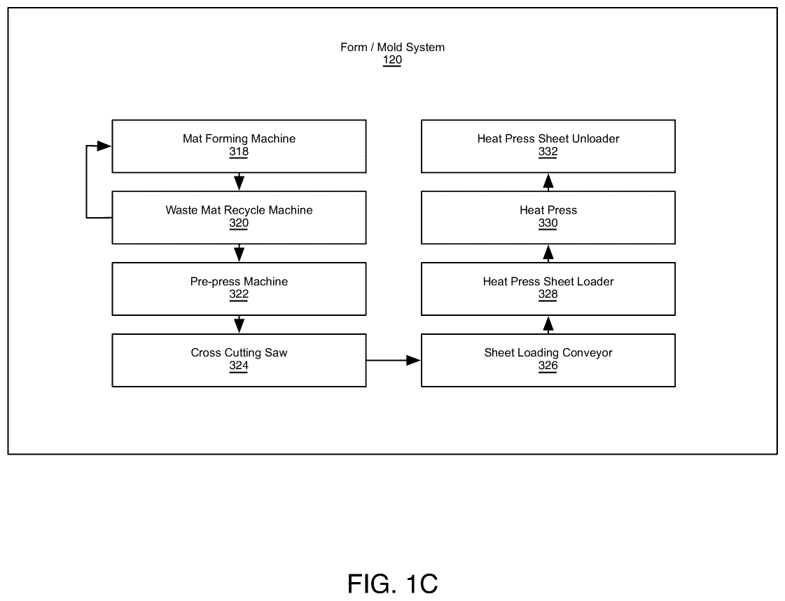

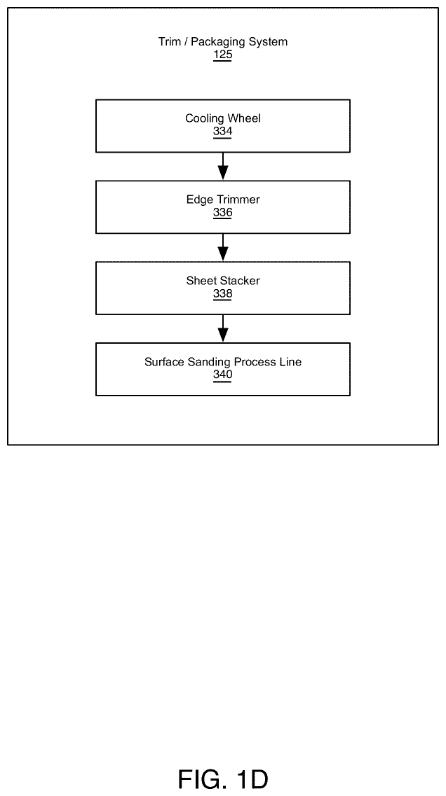

FIG. 1A shows a manufacturing system 100, in accordance with one or more embodiments. As shown in FIG. 1A, the manufacturing system 100 has multiple components including a fiber refining system 105, a resin dispensing system 110, a mixing system 115, a form/mold system 120, and a trim/packaging system 125. Various components of the manufacturing system 100 can be located on the same apparatus or can be located on separate apparatuses connected by a network (e.g., a local area network (LAN), the Internet, etc.). Those skilled in the art will appreciate that there can be more than one of each separate component within a single apparatus, as well as any combination of these components within a given embodiment.

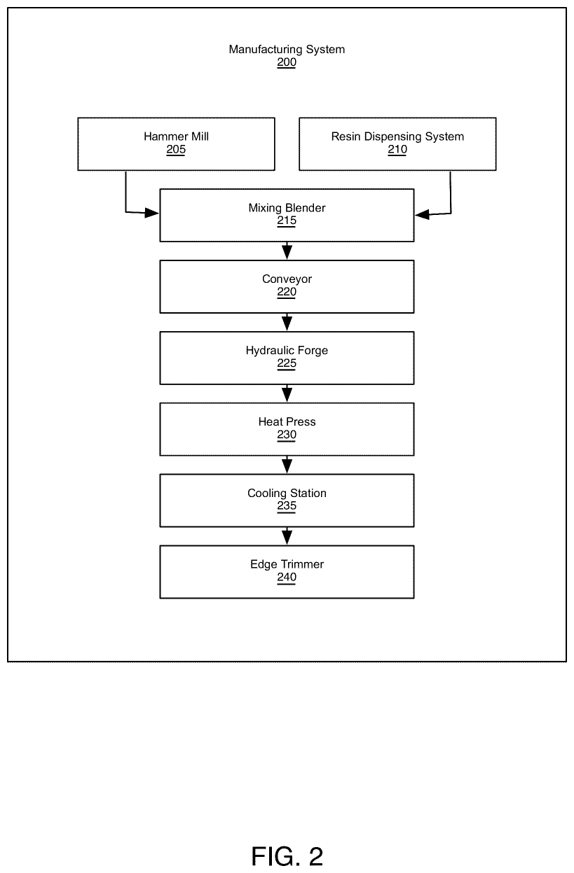

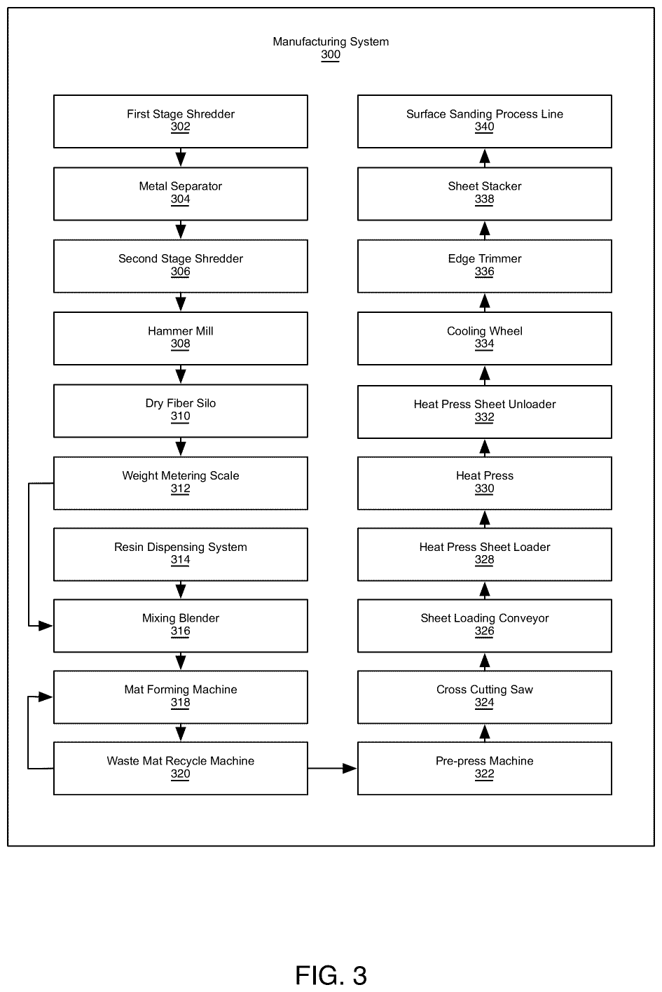

In one or more embodiments of the invention, the manufacturing system 100 includes multiple systems, each potentially including any number of apparatus. According to the specific requirements of the end product and application(s), one or more components of the system may be optional or absent within a given manufacturing process. For example, FIG. 2 and FIG. 3 both depict embodiments of a manufacturing system including common and overlapping components. Many of the components of manufacturing system 200 of FIG. 2 may be included in the manufacturing system 300 of FIG. 3, while many components of manufacturing system 300 of FIG. 3 are absent or unnecessary in manufacturing system 200 of FIG. 2. Thus, the systems and components described herein are to be construed as highly configurable and non-limiting examples.

### Fiber Refining System

In one or more embodiments of the invention, the fiber refining system 105 is designed to process fiber-containing material (e.g., cardboard) into refined fiber material. The raw material is fed into a multi-stage process where it is progressively reduced to a predetermined particle size and texture suitable for further processing.

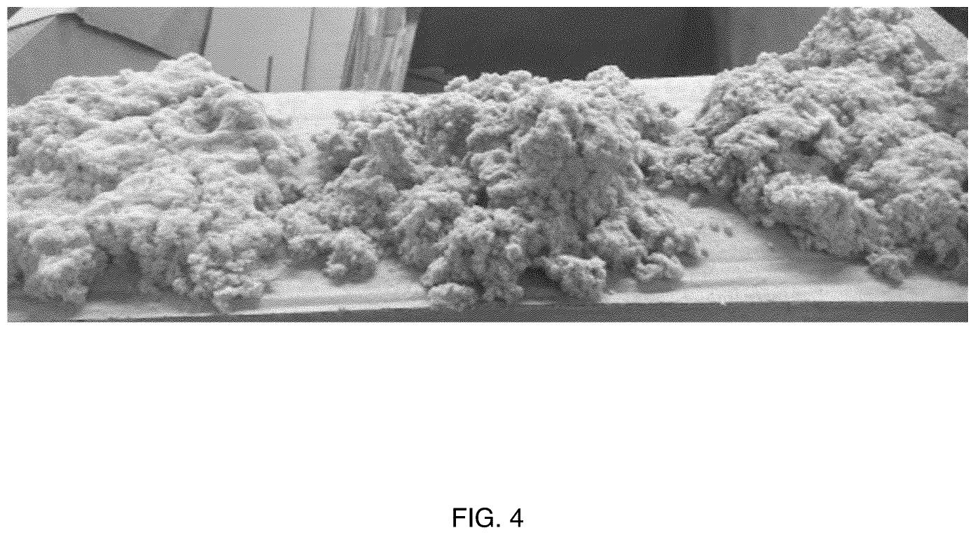

FIG. 4 shows an image of an example output of the fiber refining system: a refined fiber pulp. The characteristics of the refined fiber pulp are dependent on the configuration of the modules and processes of the fiber refining system, which can be optimized for the production of a fiber composite material that meets a variety of standards for different applications.

FIG. 1B shows a fiber refining system 105, in accordance with one or more embodiments. As shown in FIG. 1B, the fiber refining system 105 has multiple components corresponding to different stages of the refining process, including a first stage shredder 302, a metal separator 304, a second stage shredder 306, a hammer mill 308, and a dry fiber silo 310. Various components of the refining system 105 can be located on the same apparatus or can be located on separate apparatuses connected by a network (e.g., a local area network (LAN), the Internet, etc.). Those skilled in the art will appreciate that there can be more than one of each separate component within a single apparatus, as well as any combination of these components within a given embodiment.

### —First Stage Shredder

In one or more embodiments of the invention, the first stage shredder 302 is configured to process high-volume incoming cardboard material into refined fiber suitable for further manufacturing processes. The primary function of this first stage shredder is to break down the cardboard material into coarse shreds that are more manageable for subsequent processing stages which may include further shredding, milling, or pulping. Specifically, in one embodiment, the first stage shredder takes loose/baled cardboard as an input and produces large-form shredded cardboard as an output.

In one or more embodiments of the invention, the first stage shredder utilizes multiple spinning shaft blades to effectively tear apart incoming cardboard. The shredder reduces large pieces of cardboard into smaller fragments that facilitate more uniform mixing and processing in later stages of production. This initial shredding is important for ensuring the consistency of the fiber size which impacts the quality of the final composite material.

In one or more embodiments of the invention, the first stage shredder includes one or more parallel, rotating shafts equipped with high-strength steel teeth. In an illustrative example, four shafts may be utilized to achieve the desired consistency in the first stage of shredding. These shafts may be arranged so that the two center shafts sit lower than the outer shafts, creating a funneling effect for the material being fed into the shredder. This arrangement helps in drawing the cardboard into the center where it is most effectively shredded. Each shaft is powered by high torque motors that drive the shafts in opposite directions-enhancing the shredding action and preventing jams typical in high-volume processing environments. The clockwise and counterclockwise motions of the opposing shafts increase the efficiency of material breakdown, optimizing the shredding process for subsequent refining stages.

In one or more embodiments of the invention, although the term “shredder” is used to describe this component, an actual mechanical shredding device may not be required to achieve the desired output. Thus, for purposes of this disclosure, the first stage shredder and second stage shredder may be implemented with any mechanism for breaking down cardboard to smaller sizes. This can include, but is not limited to, methods such as tearing, use of scissors, box cutters, or saws, as well as more automated methods such as a motor driven saw, a rotary cutter, or chainsaw. For larger volumes, such as bales, this can be performed with a horizontal band saw or saw mill, in accordance with various embodiments of the invention.

In one or more embodiments of the invention, operational speed of the shredder and motor specifications of the first stage shredder are set to accommodate the volume of material processed, with the motors capable of running at speeds that match the material feed rate. This synchronization prevents overloading and ensures efficient material breakdown. The shredder can handle both loose and baled cardboard, allowing for flexibility in the types of raw materials processed. The output from this stage is coarse, shredded cardboard, ready for further processing.

### —Metal Separator

In one or more embodiments of the invention, the metal separator includes functionality to remove metal contaminants from the fiber material. This step prevents damage to downstream processing equipment and maintains the purity of the output fiber product.

In one or more embodiments of the invention, the metal separator may employ various mechanisms to achieve effective metal separation. One common method involves the use of a magnetic separator, which incorporates high-intensity magnets arranged in an array above a conveyor belt that transports shredded materials. These magnets attract and retain ferrous metals from the flowing material stream. Alternatively, other separation technologies such as eddy current separators can be used to remove non-ferrous metals. These systems generate a magnetic field that induces currents in non-ferrous metals, propelling them from the bulk material stream through electromagnetic repulsion.

In one or more embodiments of the invention, although the illustrative examples in the present disclosure may show the process of metal separation in a specified order, the metal separator may be utilized at various stages within the processing sequence. This separator may be utilized at multiple points throughout the processing workflow, such as before or after initial shredding, or even subsequent processing steps, to accommodate specific operational needs and improve the efficacy of metal removal. Manual methods of metal separation may be employed, involving the physical extraction of metals before or after these shredding stages. Automated separation techniques are also utilized, including flotation, which might wet the fibers but effectively separates metals. Mechanical sorting mechanisms—utilizing conveyors, vibrations, screens, air jets, and mechanical arms—offer robust solutions for metal segregation. Additionally, electrostatic separation techniques can be applied, using electrical charges to distinguish metals from non-metallic substances.

### —Second Stage Shredder

In one or more embodiments of the invention, the second stage shredder includes functionality to process previously shredded materials to a finer granularity. This stage is essential for achieving a uniform particle size that is critical for subsequent processing steps, such as blending with resins or other composites.

In one or more embodiments of the invention, the second stage shredder operates by further reducing the size of material that has been preliminarily processed by a first stage shredder. This reduction may be accomplished through a mechanism that includes a single shredding shaft equipped with high-strength steel teeth. These teeth are arranged in a manner that allows for effective shearing of the material against a particle-size-control screen. This configuration ensures that only particles small enough to pass through the screen are processed further, which standardizes the size of output material for consistent quality in downstream applications.

The operational mechanism of the second stage shredder involves the material entering a shredding chamber where it is engaged by the rotating shaft. This shaft, powered by a high-torque motor, efficiently processes the material against a replaceable screen that is available in various perforation sizes to meet different requirements. For example, if the final product requires extremely fine particles, a screen with smaller perforations might be used, while larger perforations might be suitable for coarser outputs.

As discussed above, in one or more embodiments of the invention, although the term “shredder” is used to describe this component, an actual mechanical shredding device may not be required to achieve the desired output. Thus, for purposes of this disclosure, the first stage shredder and second stage shredder may be implemented with any mechanism for breaking down cardboard to smaller sizes.

### —Hammer Mill

In one or more embodiments of the invention, the hammer mill functions to mechanically break down cardboard into milled cardboard fibers of a specific texture and size, suitable for further processing (e.g., blending with bio-based epoxy resins). In one embodiment, this is achieved through high-speed mechanical impact and attrition, where material is shredded and ground by the action of numerous fast-spinning hammer blades.

In one or more embodiments of the invention, the hammer mill includes functionality to process corrugated cardboard material into a finely pulped state without the use of water, thereby termed dry pulping. This dry pulping process is utilized for extracting micro wood fibers from paper-based products, which may be necessary for subsequent processing stages in the manufacturing of fiber composites.

In one or more embodiments of the invention, the hammer mill includes a chamber housing a rotatable shaft mounted with several steel hammers. These hammers swing outward due to centrifugal force as the shaft rotates, typically driven by an external motor through a belt system. The material, fed into the mill, is repeatedly struck by these hammers, breaking it into smaller pieces.

In one or more embodiments of the invention, the chamber contains a perforated screen at its base, which serves to control the particle size of the output by allowing only fibers small enough to pass through its openings. The size of these openings can be adjusted according to the desired output for specific production requirements. Below this screen, a turbine, either connected to the main shaft or operated by an independent motor, generates a force that facilitates the movement of the pulverized fibers out of the chamber through a discharge chute.

In one or more embodiments of the invention, the hammer mill can be implemented using various technologies depending on the specific needs of the manufacturing process. For example, the hammer mill can alternatively incorporate mechanisms typical of smaller-volume or larger-scale pulverization equipment. The implementation may range from using devices such as spice grinders and high-powered blenders, suitable for smaller production volumes, to more robust machinery such as universal mills, roller mills, and disc mills, which are advantageous for higher throughput requirements. Additionally, the size of the screen perforations in the hammer mill can be varied-smaller perforations generally prolong cycle times but may be necessary for achieving finer material granularity, whereas larger perforations facilitate faster processing at the risk of coarser output. This adaptability allows the hammer mill to be customized for optimal performance across diverse production scenarios.

### —Dry Fiber Silo

In one or more embodiments of the invention, the dry fiber silo is configured to store milled cardboard fiber in a dry state, providing a consistent feed to subsequent processing stages. This ensures that the material handling and subsequent resin impregnation/blending stages can operate efficiently without downtime related to material shortages or inconsistencies in fiber supply. The dry fiber silo helps to maintain an adequate supply of dry, milled fibers that are ready for further processing. By doing so, it enables continuous operation of the manufacturing line, particularly in systems requiring a high throughput where material readiness is crucial. The silo helps in buffering the production process from fluctuations in upstream fiber milling operations, thus stabilizing the overall manufacturing process.

In one or more embodiments of the invention, the dry fiber silo is a large container, often cylindrical and constructed from materials such as steel or reinforced polymers, which are selected based on their durability and compatibility with the stored materials. The silo is equipped with systems to maintain low humidity levels inside, ensuring that the fibers remain dry and are less likely to clump, which could interfere with their flowability and processing. The base of the silo typically incorporates a conical discharge with a motorized auger or a similar mechanism to promote the even and controlled flow of fibers into downstream processes.

In one or more embodiments of the invention, the fiber refining system may include a material refinery process that is processed through multi-stage milling and pulping equipment. Pulped material can be introduced into the process with varying degrees of particle size.

### Fiber Refining System Example

In one example, particle size of processed material can effectively range from 3.3 mm to 7.5 mm. Nominally, in this example, the fiber material is processed through a 5.5 mm perforated screen that creates the ideal processing attributes for later stages of manufacturing. The fiber material is pulped through steel hammers and strike plate machinery that is nominally operating at 3600 RPMs at 60 Hz. This success criteria and nominal range is dependent on the desired processing time and desired production output. Advantageous results may be achieved with a range of 30 RPMs to 3600 RPMs. The fiber material feed rate through the refinery process may range from 100 lbs/hr to 6T/hr. The desired feed rate is determined by the desired particle size and by the overall refinery machine processing capacity. In this example, the particle size result may decay if these processing specifications are not achieved.

### Resin Dispensing System

In one or more embodiments of the invention, the resin dispensing system 110 is configured to prepare and apply an epoxy resin to the refined fiber material. This system includes mechanisms for both the metering and mixing of the resin components before application. Specialized components of the system enable even distribution of the resin across the refined fiber material. The system can operate within predefined parameters (e.g., temperature, pressure, etc.) suitable to achieve an effective atomization particle size, ensuring thorough coating of the fibers.

In one or more embodiments of the invention, the resin dispensing system is configured to prepare and apply various types of epoxy resins, including bio-based options, to refined fiber material with high efficiency and uniformity. This system ensures that the resin is applied evenly and with the right parameters for optimizing the physical and chemical properties of the final composite product.

In one or more embodiments of the invention, the resin dispensing system includes several components. Storage tanks hold the epoxy resin components, which may include both traditional and bio-based variants. Metering pumps are employed to transfer precise amounts of these components to a mixing chamber. Within this chamber, mechanical agitators ensure that the components are thoroughly mixed to form a homogeneous epoxy mixture.

In one or more embodiments of the invention, once adequately mixed, the resin is moved to atomization spray nozzles that finely disperse the resin into droplets, a process critical for achieving an even coating over the fiber material. The size of these droplets may be configurable to be within a predefined range (e.g., from 0.015″ to 0.019″ or 0.381 mm to 0.483 mm), which optimizes coating efficiency. In one or more embodiments of the invention, the entire operation is orchestrated by a programmable logic controller (PLC), which regulates the pumps and valves to sync the mixing and dispensing processes with the fiber material's processing stages.

For instance, in a specific implementation, diaphragm pumps might be selected for resin transfer due to their precision and reliability. The mixing might occur at high speeds to ensure complete integration of the resin components. The spray nozzles would be configured to atomize the resin to cover a predefined width (e.g., up to 24 inches or 610 mm) at a predefined conveyor speed (e.g., 15 feet per minute or 4.57 m/min), and with predefined spray pressure range (e.g., from 2500 to 3000 psi).

In one or more embodiments of the invention, the resin dispensing system is configured to perform a “batching” process where components of the resin, which may include bio-based types, are first siphoned from storage containers into multiple batch tanks set to predefined volumes. The accuracy of the mixing ratio is maintained by ultrasonic sensors that measure the volume displacement and feed this data to the PLC, which manages the power cycles of the pumps during the batching phase. Once the components are proportioned and batched according to specific requirements, they are transferred to a mixing tank where they are combined and mechanically agitated to create a homogeneous epoxy resin solution. This method allows for precise control over the composition and quality of the resin used in the manufacturing process.

In one or more embodiments, the dosing of the resin may be quantified either by volume or by weight. For volumetric measurements, options include the manual use of standardized containers, flow meters, volumetric pumps such as positive displacement pumps, optical sensors, or image processing techniques. Alternatively, weight measurements might utilize load cells or pressure sensors to achieve the desired precision in resin dosing.

Additionally, in one or more embodiments, the mixing of resin may be conducted using various agitators regardless of the agitation path, which can be circular, figure-eight, random, or other configurations. Suitable agitators include, but are not limited to, spatulas, flat paddles, or spiral mixing paddles, all of which should be constructed from materials that do not shed particles into the mixture.

Furthermore, in one or more embodiments, to safeguard against contamination from foreign objects, the resin should be transported through tubing or contained within covered vessels. Tubing serves as an efficient conduit for moving the resin to subsequent processing stages or equipment. The resin transfer may be facilitated by pumps and can be controlled via valves, or may alternatively rely on gravity for movement.

For the dispensing of resin, one or more embodiments include atomizing the resin to ensure even distribution. This atomization can be achieved by exerting high pressure through a narrow nozzle outlet, or by directing compressed air across a resin weep port, thus creating a finely dispersed spray that promotes uniform application.

### Resin Dispensing System Example

In one example, the process may include a multi stage bio-based epoxy resin preparation and dispense process. The bio-based epoxy resin can be prepared as a single component epoxy resin and as a multi-component additive. The ratio of single part to multipart bio-based epoxy resin may be dependent on the density, thickness, weight, moisture content, fire resistance, chemical performance, and overall mechanical performance of the desired forged fiber composite material. The dispense process may require a motorized airless spray system that achieves a range of 2500-6000 psi. The pressure requirement range allows for an effective atomization particle size range of .015″-.019″ or .381 mm-.438 mm. In this example, a nominal particle size for desired impregnation of the cardboard fiber material is .019″ or .438 mm. Therefore, the desired spray pattern fan width of the atomized particles is 8″-16″ or 203.2 mm-406.4 mm. Nominal spray pattern fan width for desired impregnation of the cardboard fiber materials is 10″ or 254 mm in this example. In addition to airless spray processing the dispense process may require a compressed air system that achieves a range of 50 to 200 psi. In order to achieve the desired spray application utilizing the desired spray allocation systems, the viscosity range for the bio-based resin may need to be controlled below 300cp. Concluding the example, mix time, blending times, ambient temperatures, and recipe requirements may require a nominal range of 260-290cp for precise processing.

### Mixing System

In one or more embodiments of the invention, following the application of resin, the mixing system 115 blends the resin-applied fibers to ensure uniform distribution within the material. Various parameters of the mixing process can be controlled to produce a fiber composite material with specific properties such as uniform distribution and to avoid undesired outcomes such as premature gelation of the resin.

In one or more embodiments of the invention, the mixing system utilizes a mechanical blender equipped with various styles of blades that facilitate the thorough mixing required to embed the resin into the fibers. The specific configuration of the mixing system may include paddle blades, ribbon blades, or spear-like blades which are chosen based on the desired final properties of the composite material.

In one or more embodiments of the invention, operation of the mixing system involves feeding the milled cardboard fibers and the bio-based epoxy resin into a cylindrical blending chamber. Inside this chamber, in one embodiment, a rotating shaft with attached blades agitates the mixture to ensure even coating and integration of the resin throughout the fibrous substrate. This process achieves a homogeneous material which may be desired for the consistent mechanical properties of the final product. The mixing system is capable of adjusting the speed of the blade rotation and the duration of mixing to accommodate different types of fibers and resin formulations. Typical operational parameters might include blade speeds ranging, for example, from 30 to 600 RPM and mixing durations from 1 to 30 minutes, depending on the specific process requirements.

An exemplary mixing process might involve setting the blade speed at 100 RPM for a period of 15 minutes to blend a batch of fibers with a resin viscosity optimized for impregnation. The mixer may also be configured to operate under controlled temperature conditions, typically between 55° F. and 85° F., to prevent premature curing of the resin, which could adversely affect the material's handling and performance characteristics.

### Form/Mold System

In one or more embodiments of the invention, the form/mold system 120 includes functionality to shape the blended material into one or more predefined forms. This system can include various forming technologies, such as stationary molds or conveyor systems, equipped with temperature control capabilities to manage the curing process of the resin.

FIG. 1C shows a form/mold system 120, in accordance with one or more embodiments. As shown in FIG. 1C, the form/mold system 120 has multiple components corresponding to different stages of the refining process, including a mat forming machine 318, a waste mat recycle machine 320, a pre-press machine 322, a cross cutting saw 324, a sheet loading conveyor 326, a heat press sheet loader 328, a heat press 330, and a heat press sheet unloader 332. Various components of the form/mold system 120 can be located on the same apparatus or can be located on separate apparatuses connected by a network (e.g., a local area network (LAN), the Internet, etc.). Those skilled in the art will appreciate that there can be more than one of each separate component within a single apparatus, as well as any combination of these components within a given embodiment.

### —Mat Forming Machine

In one or more embodiments of the invention, the mat forming machine is designed to convert a mixture of resin-impregnated cardboard fibers into a continuous mat of composite material, which is then further processed to create structurally reinforced fiber boards. The mat forming machine primarily functions to lay down a continuous, even layer of the fiber-resin mixture onto a conveyor system. This mat will subsequently undergo pressing and heating to form rigid boards. The formation of the mat is critical as it ensures that the fiber distribution is homogeneous across the entire area of the mat, which helps to achieve consistent mechanical properties in the final product. In one embodiment, the input of the mat forming machine is loose, resin-impregnated, cardboard fiber and the output is a continuous mat of resin-impregnated cardboard fiber.

### —Waste Mat Recycle Machine

In one or more embodiments of the invention, the waste mat recycle machine is configured to repurpose incorrectly formed mats of fiber-resin composites. This system ensures that material efficiency is maximized by reintroducing substandard materials back into the production process, thus reducing waste and enhancing the overall sustainability of the manufacturing process. The waste mat recycle machine functions primarily to disassemble and process incorrectly formed or defective mats that do not meet quality standards. This component operates by first identifying and segregating the defective mats. It then proceeds to shred these mats into smaller, manageable pieces that are suitable for reprocessing.

### —Pre-Press Machine

In one or more embodiments of the invention, the pre-press machine aids in the initial formation of fiber-resin mats, preparing them for subsequent pressing stages in the manufacturing process of forged fiber structural composites. This machine compacts loosely formed mats of fiber-resin mixture into denser forms.

The pre-press machine consists of a series of heavy-duty, powered rollers that exert controlled pressure on the mat as it passes through them. This sequential roller system is designed to apply a specific amount of pressure, adjustable to meet the specifications of the desired end product. The pressure exerted by these rollers can be configured to range, in a non-limiting example, from 1000 to 5000 pounds per square inch (psi), which is regulated to ensure uniform density across the mat.

In one or more embodiments of the invention, the pre-press machine may alternatively utilize a forging apparatus. This substitution involves compressing each individual mat separately, which may affect the overall cycle time of the manufacturing process. Specifically, while the continuous rolling press facilitates a streamlined, uninterrupted flow of mat processing, the use of a forge necessitates individual handling and processing of each mat.

### —Cross Cutting Saw

In one or more embodiments of the invention, a cross cutting saw is utilized to cut and separate the continuous mat of fiber-resin mixture into the desired lengths to create individual pre-compressed sheets suitable for further processing. The cross cutting saw may include a saw blade aligned perpendicularly to the direction of the mat's travel across a conveyor. This alignment ensures that the cuts are made cleanly and accurately to maintain the integrity and dimensions of the sheets. The blade itself moves across the conveyor at a calculated speed that matches the conveyor's speed, allowing for continuous operation without the need to halt the mat feed. This synchronous movement helps in minimizing production downtime and maintaining a consistent flow in the manufacturing process.

The saw blade is mounted on a mechanically robust arm that can adjust the height and angle of the cut, allowing for different sheet thicknesses and sizes as required by specific production needs. The mechanical arm is equipped with precision controls to adjust the blade's movement and speed, ensuring each cut is uniform.

In one or more embodiments of the invention, the cross cutting saw may be substituted with alternative cutting devices capable of segmenting a continuous mat of fiber-resin mixture into individual mats. Examples of such alternative cutting devices include, but are not limited to, a guillotine shear and a swing beam shear. These devices provide functional equivalence by effectively separating the continuous mat into discrete segments, thus fulfilling the same operational purpose as the cross cutting saw. Each alternative device is configured to achieve precise cuts, maintaining the integrity and dimensions required for subsequent processing stages within the manufacturing system.

### —Sheet Loading Conveyor

In one or more embodiments of the invention, the sheet loading conveyor is configured to transport individual mats of pre-compressed, resin-applied cardboard fiber from the cutting area to the heat press loading system. This conveyor system comprises of a series of belt conveyors that are enhanced with sensors and automated guides to align the mats correctly as they are fed into the heat press, thus maintaining the structural integrity of the mats and avoiding damage from manual handling.

Further, the conveyor system utilizes a synchronized speed control mechanism that aligns with both the output rate of the upstream cross cutting saw and the feed requirements of the downstream heat press.

### —Heat Press Sheet Loader

In one or more embodiments of the invention, the heat press sheet loader is a mechanized system designed to facilitate the automatic loading of pre-compressed, resin-impregnated fiber mats into a heat press or forge for the curing process. This component is integral to the manufacturing line for producing molded fiber composite materials, optimizing the handling process to reduce manual labor and improve cycle times. The loader operates by sequentially receiving, aligning, and transferring the fiber mats from an upstream conveyor system to the heat press. It consists of a vertically cycling elevator-like mechanism equipped with multiple loading platforms or trays, each designed to accommodate a specific number of fiber mats, typically up to 20, depending on the system's configuration.

In one or more embodiments of the invention, the trays are filled sequentially as the mats arrive from the sheet loading conveyor. Sensors are strategically placed to ensure correct mat positioning and to verify that each tray is loaded correctly before the system cycles to the next position. Once all trays are loaded, the entire loader moves horizontally to position the trays inside the heat press, where the mats are offloaded in synchrony for pressing. The control system, typically a programmable logic controller (PLC), is programmed to manage the timing, speed, and sequence of loading operations to align with the heat press cycle, thereby minimizing downtime and maximizing throughput.

### —Hydraulic Forge (not Shown)

In one or more embodiments of the invention, the hydraulic forge is equipped with high-pressure molding assemblies that compress the fiber-resin mixture into a flat sheet form, known as a pre-compressed mat. This process prepares for further curing and finishing processes, shaping the loose, resin-impregnated fiber into a cohesive structure.

In one or more embodiments of the invention, the hydraulic forge operates as follows: Initially, loose, resin-impregnated cardboard fiber, serving as the input material, is deposited into a feed basket. This feed basket is specifically engineered to traverse above a mold, where it releases the fiber directly into the mold by opening its base. The mold features internal channels designed for the circulation of hot oil, which heats the mold to temperatures suitable for processing the input material. The geometric configuration of the mold is such that its surface area slightly exceeds the dimensions of the final product mat, and it has a depth approximately twenty times (or a configurable amount) greater than the desired thickness of the end product. Positioned above the mold, a steel top plate is placed onto the loose fibers. This plate is maneuvered into position using a hoisting mechanism. The entire mold assembly is mounted on a hydraulic shuttle system, which facilitates the movement of the mold into alignment under a compression ram. This ram, activated hydraulically, compresses the resin-impregnated fiber contained within the mold against the steel top plate. The force exerted by the ram and the duration of compression are calibrated to produce the desired thickness and density of the resulting mat, here referred to as a pre-compressed cardboard fiber mat, which constitutes the output of this process.

In one or more embodiments of the invention, the forge's dual-sided architecture allows it to operate concurrently on two lines, significantly reducing cycle times. This feature enables one side of the forge to commence refilling processes immediately after the other side completes compression, thus optimizing continuous operation cycles.

In one or more embodiments of the invention, after the compression cycle concludes and the mold returns to its initial position, a series of hydraulic pistons elevate the base of the mold along with the compressed mat and the top plate. Subsequently, the top plate is removed, and the formed mat is expelled from the mold base onto a hoist-driven elevator. This elevator then transports the mat to the next stage of the production process, while the mold base resets to its starting position, prepared for the next cycle.

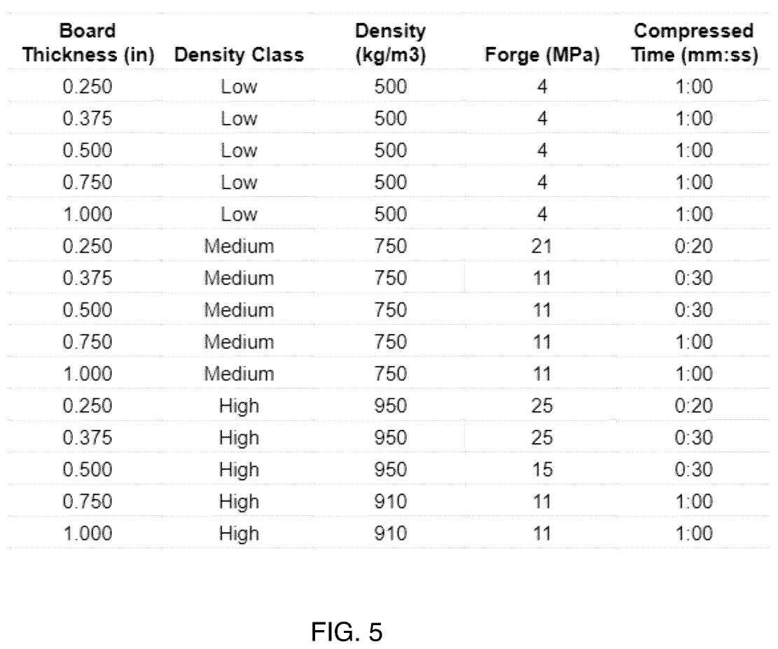

In one or more embodiments of the invention, the process of forming and/or forging may involve variations of time and pressure to form the desired density, thickness, weight, and appearance of the forged fiber board. For example, time under pressure can range from 20-60 seconds depending on the dimensional requirements of the finished product. Time under pressure may also vary and change if new upcycled materials are introduced into the product. The compression pressure required may range from 4-25 MPa. The pressure and time applied to the forged fiber board composite material may achieve a final density product state of 500-1200 kg/m3. FIG. 5 shows a table illustrating various metrics associated with example materials produced using a forge press process, in accordance with one or more embodiments.

As described herein, the forged fiber board composite may be formed by using a stationary mold or a mat forming conveyor process. The forged fiber board composite material can be molded under ambient conditions or accelerated by increasing the temperature of the stationary mold. In one example, increasing the temperature of the mold can be achieved by actively pumping thermal oil into the walls of the mold. In this example, the active temperature of the mold varies from 131-248F depending on the desired dimensional requirements of the composite material and the active mold temperature is operated at 158F for selected forming conditions of the forged fiber board.

### —Heat Press

In one or more embodiments of the invention, the heat press is configured to transform blended resin-applied cardboard fibers into a molded fiber composite material of a predefined shape and density. The heat press system can include multiple layers of mechanical shims and a stationary mold or a mat forming conveyor apparatus, which are integral in shaping the resin-applied cardboard fibers. The heat press may also include an oil pump for pumping thermal oil to regulate the temperature of the mold during the formation process.

In one or more embodiments of the invention, the stationary mold within the heat press is designed with integrated channels for the circulation of thermal oil, which heats the mold uniformly. This ensures that the heat is distributed evenly across the mold's surface, critical for achieving uniform material properties throughout the composite. In one or more embodiments of the invention, the heat press is configured to control the active temperature of the mold to within a predefined range, optimizing the material properties of the bio-based epoxy resin and the cardboard fibers. The system can adjust the temperature to suit different resin formulations and composite material specifications.

In one or more embodiments of the invention, the mechanical shims within the heat press are used to set the thickness and density of the fiber composite materials. These shims can be adjusted or replaced to produce materials of different thicknesses and densities, providing flexibility in the manufacturing process.

In one or more embodiments of the invention, the heat press forming system is adaptable to various operational settings to optimize production efficiency and product quality. This system allows for a range of operational variations, including different temperature set points, compression times, and methods of heating, to accommodate specific production requirements and to achieve desired material properties.

In one or more embodiments of the invention, the heat press forming system is capable of operating under various temperature and compression settings. While standard operating conditions are set to minimize cycle times, effective results can still be achieved with lesser or no heat application, albeit with increased cycle times. This flexibility in temperature settings allows the system to be tailored to different resin formulations, which might react differently under heat. Similarly, compression times can be varied; shorter times for processes optimized for speed and longer durations where material integrity requires more sustained pressure.

In one or more embodiments of the invention, the distance between the platens of the heat press can be adjusted to accommodate different thickness targets, which depend on the thickness of the shims used. Achieving specific thickness targets can also involve careful control of related parameters such as fiber mass, resin-to-fiber ratio, and the compression force and duration applied during the heat press cycle. Adjustments in these parameters can compensate for any potential material shrinkage during the cooling process, ensuring the final product meets precise dimensional standards.

The number of active layers in the heat press can be varied to meet production volume requirements or to align with the physical constraints of the manufacturing facility. The heat press can utilize various types of thermally conductive liquids other than heating oil for temperature regulation. Alternative heating methods such as electric heating, resistance induction, steam heating, and gas heating are also viable, offering further versatility in how heat is applied during the pressing process. These alternatives can be particularly useful in scenarios where the traditional heating oil system may not be suitable or optimal due to environmental, safety, or economic considerations.

### —Cooling Station (not Shown)

In one or more embodiments of the invention, the cooling station serves to reduce the temperature of composite fiber sheets from a higher operational temperature to a lower, more manageable level suitable for further handling or processing. This component of the system is essential for maintaining the structural integrity and dimensional accuracy of the sheets by preventing warpage through controlled cooling. The cooling station consists of multiple storage racks outfitted with ventilated layers that promote even heat dissipation from the composite fiber sheets. The racks include perforated shelves specifically designed to enhance air circulation, leveraging both natural convection currents and mechanically assisted airflow to cool the sheets effectively.

For instance, a cooling process may be implemented where, upon exiting the heat press at approximately 190° C., the composite fiber sheets are subjected to a high-speed fan system integrated within the rack design. For example, the system may be configured to rapidly cool the sheets to below 100° C. within a ten-minute period, subsequently allowing the sheets to reach room temperature over the next twenty minutes. Gradual cooling may help to ensure that the sheets solidify in their desired form without internal stresses that could lead to deformation.

In one or more embodiments of the invention, optional variations of the cooling station include methods such as convective and conductive cooling. Convective cooling might be enhanced by directing either ambient or chilled air over the sheets using powerful industrial fans or specially configured HVAC systems for high airflow. Conductive cooling could involve placing the heated sheets on chilled conductive surfaces like metal plates, which can absorb heat from the sheets more rapidly and efficiently than air.

In one or more embodiments of the invention, the cooling racks are integrated with automated sheet transfer systems, which transport the sheets from the heat press to the cooling station without manual handling, thereby minimizing heat loss and enhancing process efficiency.

### —Heat Press Sheet Unloader

In one or more embodiments of the invention, the heat press sheet unloader is configured to remove molded fiber composite materials from the heat press and transport them to subsequent processing stations such as cooling racks or trimming areas.

In one or more embodiments of the invention, the heat press sheet unloader includes an elevator-like mechanism that operates to vertically cycle between different levels; each corresponding to the heat press's operational layers. It is designed to unload multiple composite fiber sheets simultaneously and feed them individually into the downstream process. This unloader is mechanically synchronized with the heat press's release cycle to ensure that the sheets are handled efficiently and without delay, thereby minimizing potential exposure to temperatures that could compromise their structural integrity.

An operational example of the heat press sheet unloader involves its integration with a heat press configured to process 20 layers of composite fiber sheets. Once the heat press cycle is complete, the unloader activates. The unloader, using a series of pneumatic or hydraulic pistons, aligns its platform with the layers of the heat press. The sheets are then pushed onto the platform of the unloader. This platform vertically transports the sheets from the high-temperature environment of the press to an ambient environment where the sheets can be handled safely. In this example, the unloader's elevator mechanism is designed to accommodate a predefined number of sheets, typically up to 20, in a single cycle. Each layer of the elevator corresponds to a layer in the heat press, ensuring that all sheets are unloaded simultaneously to maximize efficiency.

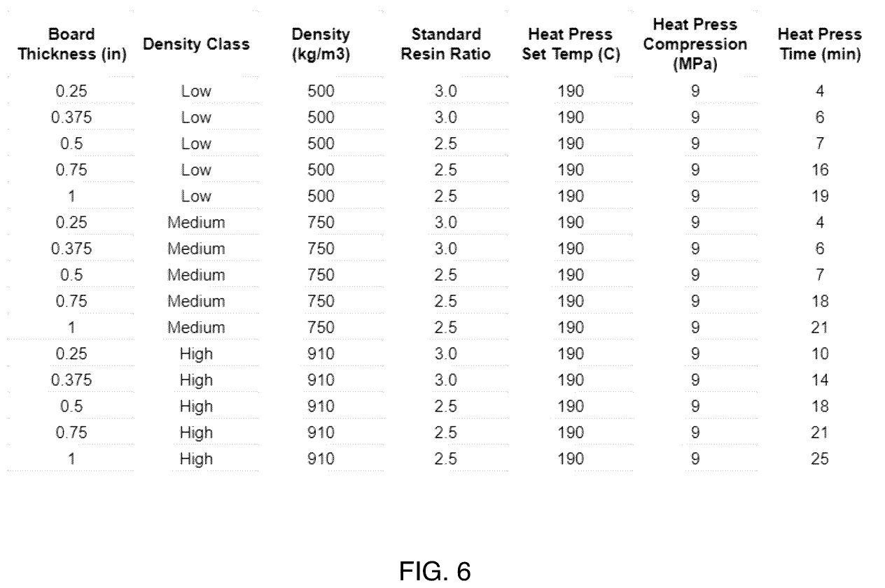

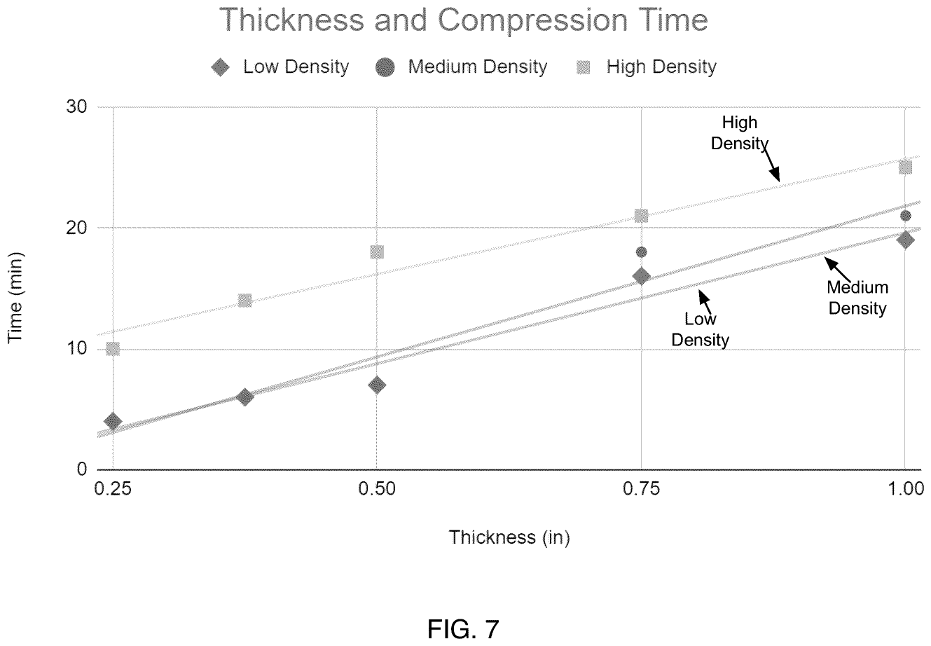

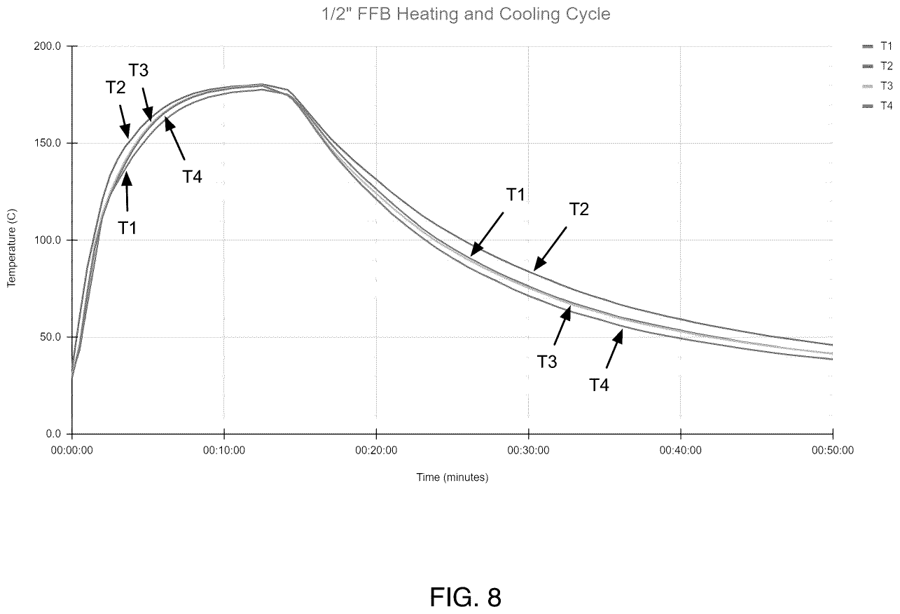

In one or more embodiments of the invention, the process of the form/molding system may involve variations of direct heat, time, and compression to form the desired density, thickness, weight, and appearance of the forged fiber board. For example, time under direct heat and compression pressure can range from 4-25 minutes depending on the dimensional requirements of the finished product and on the gelation to cure cycles. FIG. 6 shows a table illustrating various metrics associated with materials produced using the described heat press process, in accordance with one or more embodiments. Compression with direct heat applied during the gelation period and cure phases is critical for forged fiber board product success. Cold compression is possible, but is not operationally efficient, therefore the cure cycle is accelerated during compression via direct heat. Cure cycles may extend between 1-7 days if left to ambient environment curing without direct heat applied. Precise compression with direct heat further allows for thickness and density control. In one example process, the compression pressure required may range from 2 MPa for lower density products to 15 MPa for high density products. In this example, for nominal gelation and curing, the internal temperature of the upcycled cardboard fiber mixed with bio-based epoxy resins must reach an internal temperature of 170C or 338F during the direct heat compression process for sufficient curing of the material to exist. Once the peak exothermic reaction has occurred, the material begins to cool and is able to be handled for continued processing. In order to achieve the desired processing time and temperature, the heat press machinery will nominally be operating at a predefined temperature or range (e.g., 190C or 374F). Additionally, in one or more embodiments of the invention, it may be required to utilize mechanical shims to achieve the desired thickness and dimensional requirements of the product. The mechanical shim sizes will vary depending on the desired thickness and density of the finished product. FIG. 7 shows a graph depicting sample thickness versus compression time for manufacture of various cardboard fiber composites, in accordance with one or more embodiments. While it is intuitive that a thicker and/or denser product would need more time, FIG. 7 shows that this is not perfectly linear. Experimental data was required to identify production parameters for each product density and thickness. FIG. 8 shows a graph depicting the heating and cooling cycle in the manufacture of a cardboard fiber composite, in accordance with one or more embodiments. FIG. 8 depicts time required to achieve sufficient resin gel/cure to allow handling of the resulting material. The example of FIG. 8 includes temperature readings from four different thermocouples (T1-T4) across the same part of the sheet.

### Trim/Packaging System

FIG. 1D shows a trim/packaging system 125, in accordance with one or more embodiments. As shown in FIG. 1D, the trim/packaging system 125 has multiple components corresponding to different stages of the refining process, including a cooling wheel 334, and edge trimmer 336, a sheet stacker 338, and a surface sanding process line 340. Various components of the trim/packaging system 125 can be located on the same apparatus or can be located on separate apparatuses connected by a network (e.g., a local area network (LAN), the Internet, etc.). Those skilled in the art will appreciate that there can be more than one of each separate component within a single apparatus, as well as any combination of these components within a given embodiment.

In one or more embodiments of the invention, the trim/packaging system handles the final stages of the manufacturing process, including cooling, trimming to size, and packaging of the composite sheets. The system includes a variety of tools and devices for preparing the final product for distribution.

### —Cooling Wheel

In one or more embodiments of the invention, the cooling wheel is configured to reduce the temperature of the sheets from an elevated processing temperature to a safer, more manageable temperature that prepares them for subsequent handling, trimming, and packaging operations. In one embodiment, the cooling wheel comprises a set of large, hollow, cylindrical wheels that rotate slowly. This rotation is purposefully controlled to extend the cooling duration, thereby ensuring gradual and uniform heat dissipation from the fiber composite sheets. By spinning the sheets slowly and steadily, the wheel facilitates convective cooling, leveraging ambient air to enhance the cooling process. This method ensures that the composite sheets do not warp or deform, maintaining their flatness and structural integrity as they cool down.

For instance, consider a cooling wheel designed to handle composite fiber sheets exiting a press forming system at temperatures around 190° C. (374° F.). The cooling wheel, through its slow rotational mechanism, might be set to rotate at 10 revolutions per minute. The sheets are loaded onto the wheel's surface. As the wheel turns, ambient air naturally cools the sheets. Optionally, fans could be installed to blow room temperature or slightly chilled air (approximately 25° C. or 77° F.) across the sheets to expedite cooling. In this example, the target is to reduce the sheet temperature to about 85° C. (185° F.) by the time they exit the wheel. This gradual cooling process prevents thermal shock, which could lead to material stresses or imperfections in the final product.

In one or more embodiments of the invention, cooling can be achieved by convective or conductive methods. Convective cooling can be aided by cooled ambient air and/or a fan blowing room temperature or chilled air over the composite sheets. Conductive cooling can be performed by placing composite fiber sheets on or in between chilled conductive materials, such as a steel plate.

### —Edge Trimmer

In one or more embodiments of the invention, the edge trimmer is configured to cut and trim off excess edges from composite fiber sheets, thereby achieving the desired final dimensions and edge profiles with high precision. This ensures that the sheets meet specified size requirements and quality standards, which are essential for subsequent uses in various industrial applications.

The edge trimmer incorporates a combination of rotary saw blades aligned in sequence. These blades are designed to work together systematically to trim the edges of the composite fiber sheets as they are fed through the trimming station. The edge trimmer includes pneumatic actuated clamps that securely hold the composite fiber sheet in place on a shuttle. This shuttle moves the sheet sequentially through the sets of parallel rotary saw blades to perform the cutting action. As the sheet reaches the end of its travel along one axis, the clamps release, and a secondary shuttle mechanism engages. This secondary shuttle pushes the sheet perpendicularly to its initial path, aligning it with another set of saws that trim the remaining uncut edges. This two-stage, cross-cutting process ensures that all edges are trimmed uniformly, maintaining the squareness and parallelism of the sheet.

In other embodiments, the edge trimmer may include different configurations of saw blades, such as diamond-tipped blades for enhanced cutting precision on harder composite materials. Furthermore, the shuttle system can be equipped with advanced sensors and control systems that automatically adjust the blade speed and feed rate based on the thickness and material properties of the composite fiber sheet being processed. Additionally, for manufacturing environments focusing on high-throughput production, multiple edge trimmers can be arranged in parallel, each configured to sequentially process batches of sheets, thereby increasing the overall efficiency and output of the manufacturing system.

### —Sheet Stacker

In one or more embodiments of the invention, a sheet stacker includes functionality to automate the stacking of composite fiber sheets into orderly stacks for further handling, storage, or packaging. The sheet stacker collects processed sheets as they exit the production line and stack them in a precise, predetermined order and orientation (e.g., onto a pallet) to facilitate easy transportation and further processing.

In one or more embodiments of the invention, the sheet stacker utilizes a mechanical assembly comprising a shuttle system and actuating pistons to transfer and accurately stack composite fiber sheets. As sheets exit the edge trimmer, they are guided onto a waiting pallet by a shuttle mechanism. This transfer is facilitated by the shuttle moving horizontally to position the sheet appropriately over the pallet. Once the sheet is positioned over the pallet, two sets of perpendicular pistons are actuated. These pistons extend to push the sheet against the fixed boundaries of the pallet—typically the walls or other stacked sheets—ensuring that each sheet is aligned precisely with the edges and corners of the stack below. This process repeats with each sheet, maintaining the stack's integrity and alignment.

In one or more embodiments of the invention, each composite fiber sheet, upon exiting the edge trimming phase, is mechanically moved by a second shuttle designed to slide the sheet directly onto a pallet positioned adjacent to the output of the edge trimmer. Once a sheet is placed on the pallet, a set of actuating pistons—arranged perpendicularly—engages to push the sheet snugly against the existing stack. This dual-action of the pistons ensures that the sheet is not only aligned longitudinally but also laterally, thereby maximizing the usable area of the pallet and enhancing stack stability.

In one or more embodiments of the invention, the stacking of sheets can be executed through various methods, ranging from manual positioning to fully automated systems, depending on the specific requirements of the manufacturing process and the physical properties of the sheets being handled.

### —Surface Sanding Process Line

In one or more embodiments of the invention, the surface sanding process line includes a set of double-faced sanding machines designed to remove any surface contamination while accurately controlling the sheet thickness into the ideal range. The surface sanding process line obtains an input of a stack of composite fiber sheets and generates an output of thickness-controlled composite fiber sheets. A variety of different optional variations can be configured, including adjustable sand paper grit, drum diameter, drum rotational speed, and feed rate to meet surface finish requirements. In one embodiment, surface sanding equipment of the surface sanding process line can be replaced with a planer.

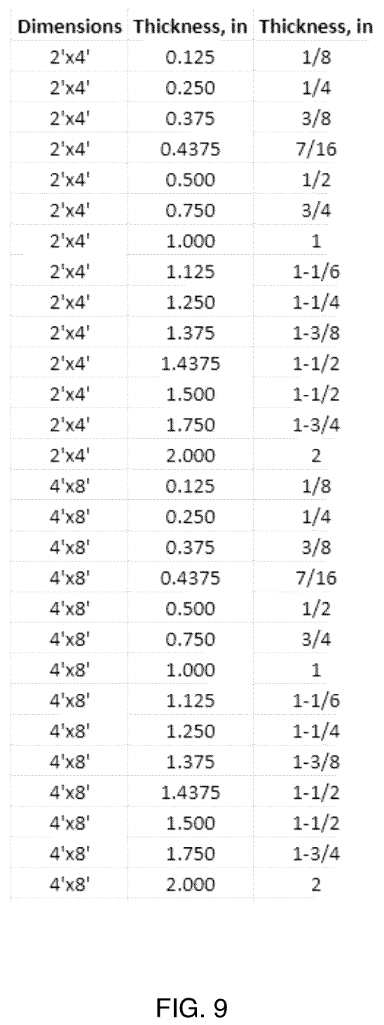

FIG. 9 shows a table illustrating dimensions of various cardboard fiber composite materials that can be manufactured and their specific associated sheet sizes, in accordance with one or more embodiments. Embodiments of the invention provide for a composite material having a range of tensile strength of 1000-8000 psi that is dependent on the desired density, thickness, weight, and appearance of the forged fiber board. Embodiments of the invention provide for a composite material having a range of flexural strength of 1000-7000 psi that is dependent on the desired density, thickness, weight, and appearance of the forged fiber board. Embodiments of the invention provide for a composite material having a range of compressive strength of 1000-6000 psi that is dependent on the desired density, thickness, weight, and appearance of the forged fiber board. Embodiments of the invention provide for a composite material with water resistance properties and/or fire resistant properties, due to the composition of the material and the method in which the material is processed.

### Applications

In one or more embodiments of the invention, the fiber composite material produced by the described method involves upcycling cardboard fiber (including waste streams) into a composite material capable of replacing Medium Density Fiberboard (MDF), High Density Fiberboard (HDF), and a variety of other materials in various structural and non-structural applications. This offers numerous potential benefits over traditional MDF and HDF materials, including enhanced sustainability, reduced environmental impact, improved mechanical properties, lower cost of production, and broader application versatility.

In addition to the toxicity levels associated with conventional building materials, the ongoing environmental repercussions of deforestation persist. The escalating demand for timber and lumber, driven by global economic growth, exacerbates this issue. Urgent calls from world leaders for immediate action to curb deforestation underscore the need to transition away from reliance on raw resources. Deforestation contributes significantly to climate change, manifesting in phenomena such as soil erosion, food insecurity, disruption of the water cycle, loss of biodiversity, flooding, and altered weather patterns.

Simultaneously, the adverse impacts of landfills are increasingly pronounced and widespread worldwide. The emission of carbon dioxide and methane from landfills remains a substantial driver of accelerated climate change. Yet, the adverse effects extend beyond greenhouse gas emissions to encompass other issues, including the generation of leachates. While some landfills incorporate leachate drainage and filtration systems, many lack such infrastructure. Consequently, untreated leachates containing toxic chemicals infiltrate freshwater streams and contaminate surrounding soil. The persistent contamination poses risks to biodiversity and poses direct threats to human health.

In one or more embodiments of the invention, the fiber composite material produced by the described method has a wide range of potential structural and non-structural applications, including but not limited to the following:

Building Construction: It can be used in construction for making structural elements like beams, columns, and panels, offering high strength-to-weight ratio and resistance to environmental factors.

Renewable Energy Structures: The material can be utilized in wind turbine blades, solar panel frames, and other renewable energy structures due to its strength, durability, eco-friendly materials, and lightweight nature.

Industrial Applications: It can be employed in industrial settings for making equipment housings, machine components, and structural supports, offering high strength and resistance to wear and tear.

Infrastructure: The material can be used in infrastructure projects for making bridges, walkways, and platforms, providing high strength and durability while reducing weight.

Packaging: The material can be used in packaging applications for making lightweight and eco-friendly packaging solutions such as boxes, trays, and containers.

Furniture: It can be utilized in furniture manufacturing for making chairs, tables, and shelves, offering a combination of strength, durability, and aesthetic appeal.

Consumer Goods: The material can be employed in consumer goods such as laptop casings, smartphone covers, and kitchenware, providing lightweight and durable solutions.

Decorative Applications: The material can be used for decorative purposes such as wall panels, decorative trims, and signage, offering a combination of aesthetics and durability.

Green Technology: It can be utilized in green technology applications such sustainable packaging solutions due to its eco-friendly properties and recyclability.

Agricultural Products: The material can be used in agricultural applications for making lightweight and durable farming equipment, greenhouse structures, and irrigation systems.

The systems described in the present disclosure may depict communication and the exchange of information between components using directional and bidirectional lines. Neither is intended to convey exclusive directionality (or lack thereof), and in some cases components are configured to communicate despite having no such depiction in the corresponding figures. Thus, the depiction of these components is intended to be exemplary and non-limiting. For example, one or more of the components of the manufacturing system 100 may be communicatively coupled via a distributed computing system, a cloud computing system, or a networked computer system communicating via the Internet.

### Flowcharts

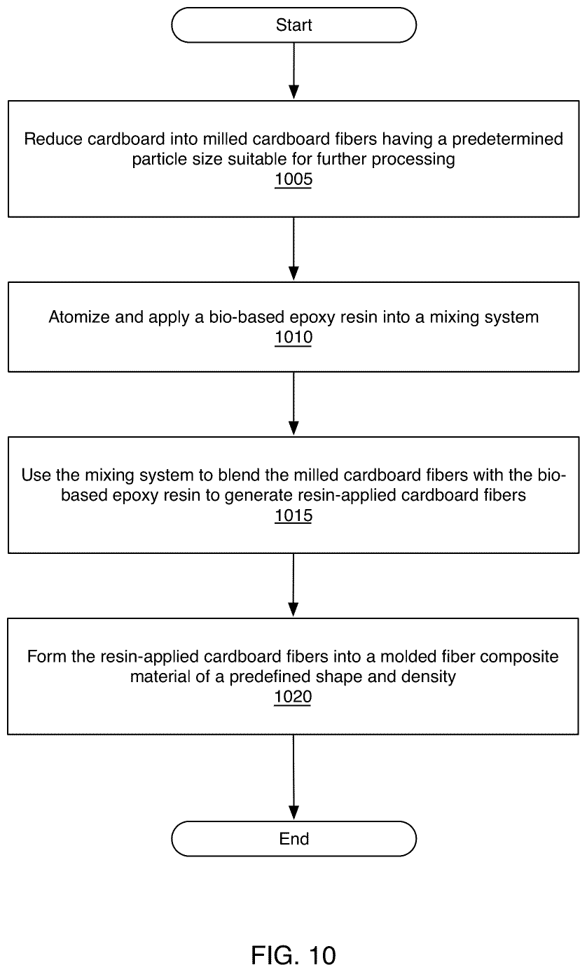

FIG. 10 shows a flowchart of a method for manufacturing a cardboard fiber composite. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 10 should not be construed as limiting the scope of the invention.

In STEP 1005, cardboard is reduced into milled cardboard fibers of a predetermined size suitable for further processing. This involves shredding the cardboard using equipment such as a quad shaft shredder to break it into large form shreds, followed by further size reduction using the single shaft shredder or hammer mill to achieve the desired particle size.

In STEP 1010, a bio-based epoxy resin is atomized and applied into a mixing system using a resin dispensing system. This system may extract two-part epoxy resin from supply tanks and delivers a controlled mixture of resin via atomization spray nozzles into the mixing blender.

In STEP 1015, the milled cardboard fibers are blended with the atomized epoxy resin in the mixing system. A mixing blender thoroughly mixes and combines the cardboard fibers with the resin at a predetermined ratio to generate resin-applied cardboard fibers.

In STEP 1020, the resin-applied cardboard fibers are formed into a molded fiber composite material of a predefined shape and density. This involves processes such as mat forming using a mat forming machine to turn the fiber-resin mixture into a continuous and evenly spread mat, followed by pre-compression using a pre-press machine to increase density, and cutting using the cross cutting saw to separate the continuous mat into individual sheets. Finally, the sheets are loaded into a heat press where they are cured under high heat and pressure to form the final composite fiber sheets.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Although components of one or more systems disclosed herein may be depicted as being directly operatively coupled to one another, this is not necessarily the case. For example, one or more of the components may be coupled via a conveyor system or intermediary component that is not shown.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for manufacturing a cardboard fiber composite, comprising:
a multi-stage fiber refining system configured to generate milled cardboard fibers by reducing cardboard into a predetermined particle size threshold suitable for further processing;
a bio-based epoxy resin dispensing system including a motorized airless sprayer configured to generate resin-applied cardboard fibers by atomizing and applying a bio-based epoxy resin into a mixing system;
the mixing system comprising a mixer equipped with a plurality of blades, configured to blend the resin-applied cardboard fibers with the bio-based epoxy resin to a predefined distribution threshold; and
a heat press forming system comprising at least one mechanical shim, configured to form the blended resin-applied cardboard fibers into a molded fiber composite material of a predefined shape and density.

2. The system of claim 1, wherein the bio-based epoxy resin dispensing system further comprises a compressed air system configured to optimize application of the bio-based epoxy resin ensuring uniform coating.

3. The system of claim 1, wherein the plurality of blades comprises at least one selected from a group consisting of paddle blades, ribbon blades, and spear-like blades.

4. The system of claim 1, wherein the heat press forming system further comprises at least one selected from a group consisting of a stationary mold and a mat forming conveyor apparatus for the formation of the resin-applied cardboard fibers into the molded fiber composite material.

5. The system of claim 4, wherein the heat press forming system further comprises an oil pump configured to pump thermal oil into walls of the stationary mold to control temperature during the formation of the resin-applied cardboard fibers into the molded fiber composite material.

6. The system of claim 5, wherein the heat press forming system is configured to control an active temperature of the stationary mold to within a predefined range depending on a predefined set of requirements and properties of the bio-based epoxy resin.

7. The system of claim 1, wherein the heat press forming system is configured to use a plurality of mechanical shims comprising the mechanical shim, wherein each of the plurality of mechanical shims is configurable to produce fiber composite materials of different thicknesses and densities.

8. The system of claim 1, wherein the multi-stage fiber refining system is further configured to: (i) adjust a particle size of the milled cardboard fibers to a predefined particle size range, (ii) operate within a variable rotation per-minute (RPM) range, and (iii) accommodate different material feed rates to suit various production requirements.

9. The system of claim 1, wherein the bio-based epoxy resin dispensing system is further configured to: (i) operate within a predefined pressure range, (ii) achieve a predefined effective atomization particle size range, and (iii) generate a desired spray pattern fan width.

10. The system of claim 1, wherein the heat press forming system is further configured to: (i) apply a predefined compression pressure and (ii) adjust compression duration based on a desired thickness and a desired final density of the molded fiber composite material

11. A system for manufacturing fiber composites, comprising:
a multi-stage fiber refining system configured to generate milled fiber pulp by reducing fiber material into a predetermined particle size threshold suitable for further processing;
a resin treatment system configured to apply a resin into a blending apparatus;
the blending apparatus for blending the fiber pulp with the resin to generate resin-applied fiber material, wherein the blending apparatus is configured to distribute the resin to within a predefined threshold of uniformity; and
a press forming system capable of shaping the resin-applied fiber material into fiber composites of multiple shapes and densities using at least one selected from a group consisting of heat pressing, cold pressing, and ambient temperature pressing.

12. The system of claim 11, wherein the multi-stage fiber refining system generates milled fiber pulp by utilizing one selected from a group consisting of a mechanical and laser-based cutting mechanism.

13. The system of claim 11, further comprising:
a curing station configured to employ at least one selected from a group consisting of UV light, heat, and chemical curing agents to stabilize the fiber composites before final processing.

14. A method for manufacturing a cardboard fiber composite, comprising:
reducing cardboard into milled cardboard fibers having a predetermined particle size suitable for further processing;
atomizing and applying a bio-based epoxy resin into a mixing system;
using the mixing system to blend the milled cardboard fibers with the bio-based epoxy resin to generate resin-applied cardboard fibers; and
forming the resin-applied cardboard fibers into a molded fiber composite material of a predefined shape and density.

15. The method of claim 14, further comprising:
optimizing application of the bio-based epoxy resin to ensure uniform coating using a compressed air system.

16. The method of claim 14, further comprising:
forming the resin-applied cardboard fibers into the molded fiber composite material using at least one forming apparatus selected from a group consisting of a stationary mold and a mat forming conveyor apparatus.

17. The method of claim 16, further comprising:
actively controlling temperature of the stationary mold during forming by pumping thermal oil into walls of the stationary mold.

18. The method of claim 14, further comprising:
using a plurality of mechanical shims when forming the resin-applied cardboard fibers to produce fiber composite materials of different thicknesses and densities.

19. The method of claim 14, further comprising:
maintaining ambient temperatures between a predefined range to mitigate early gelation risk while blending the milled cardboard fibers with the bio-based epoxy resin.

20. The method of claim 14, wherein forming the resin-applied cardboard fibers into a molded fiber composite material comprises applying compression pressure within a predefined range and adjusting compression duration based on a desired thickness and a desired final density of the molded fiber composite material.
